(19) United States
(12) Patent Application Publication
(10) Pub. No.: US 2014/0078801 A1
(43) Pub. Date: Mar. 20, 2014

(54) ADVANCED DC VOLTAGE ADJUSTMENT USING SWITCHED CAPACITORS

(71) Applicant: Adam Timmons, Birmingham, MI (US)

(72) Inventor: Adam Timmons, Birmingham, MI (US)

(73) Assignee: CHRYSLER GROUP LLC, Auburn Hills, MI (US)

(21) Appl. No.: 13/621,529

(22) Filed: Sep. 17, 2012

(51) Int. Cl. G05F 3/08; H02M 7/537

(52) U.S. Cl. 363/131; 323/311

(57) ABSTRACT

A voltage booster system for use, for example, in an electric vehicle places a switched capacitor voltage converter between a high voltage battery and the vehicle's electrical load, typically a traction power inverter for driving the vehicle's electric motor. The battery input to the converter is pulsed to couple a charging voltage to the converter while the converter is disconnected from the load. The converter is then coupled to the load during the period that the pulse input is disconnected.

### FIELD

The present disclosure relates to DC voltage conversion or adjustment. More particularly, the disclosure concerns boosting the battery cell voltage available in an electric vehicle.

### BACKGROUND

Required number of high voltage (i.e., on the order of 350-400 volts, and higher) battery cells can lead to an increased expense of an electric motor driven vehicle. Hence, attempts have been made to maintain the required system voltage with fewer battery cells by employing voltage converters. However, conventional DC-DC voltage converters employing inductive elements are very expensive and add unwanted weight to the vehicle.

There is a need for maintaining a target voltage with a minimum number of required battery cells in a cost-effective manner.

### SUMMARY

In one aspect of the disclosure, a voltage booster system includes a battery coupled to a first bus, a switched capacitor voltage converter having an input coupled to the first bus and an output coupled to an electric load via a second bus. The converter includes at least first and second capacitors coupled to a plurality of switches. A control unit is operative to provide a pulsating voltage to the converter input via the plurality of switches. The pulsating voltage varies between a preselected voltage level during a first phase and a substantially zero voltage during a second phase. The controller is further operative to control the plurality of switches so as to couple the at least first and second capacitors in parallel during the first phase and so as to couple the at least first and second capacitors in series during the second phase.

In another aspect of the disclosure, a method for boosting voltage available from a battery system driving an electric load includes placing a switched capacitor voltage converter between the battery system and the load. The battery system is coupled to the converter and the converter is decoupled from the load during a first phase of operation. The battery system is decoupled from the converter and the converter is coupled to the load during a second phase of operation. The at least first and second capacitors of the converter are placed in parallel across a battery system output during the first phase. The at least first and second capacitors of the converter are configured in series across an output of the converter during the second phase.

Further areas of applicability of the teachings of the present disclosure will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present disclosure are intended to be within the scope of the present disclosure.

### BRIEF DESCRIPTION OF THE DRAWINGS

FIG. 1 is a block diagram of a voltage booster system arranged in accordance with the principles of the invention; and

FIG. 2 is a timing diagram showing the voltage output from the voltage booster.

### DETAILED DESCRIPTION

The system of the disclosure aims to obtain adequate electric vehicle drive voltage with a reduced number of battery cells by driving a switched capacitor voltage converter with a pulsed input from the battery system.

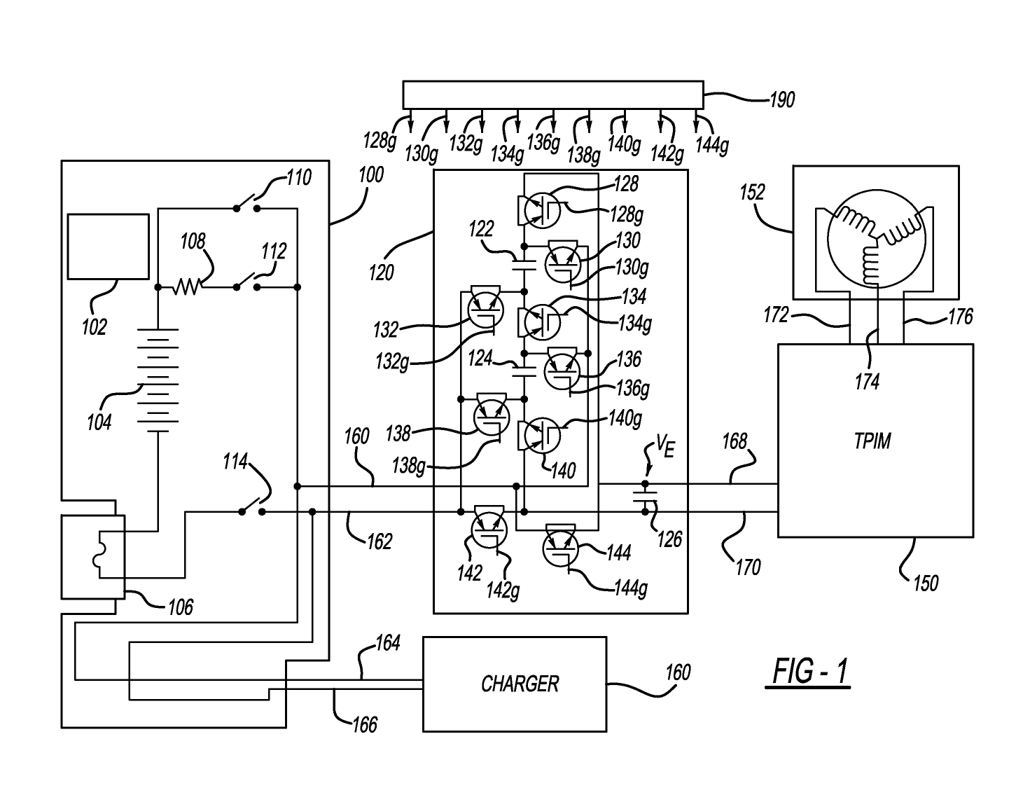

With reference to FIG. 1, an electric vehicle power system includes a high voltage battery system 100. High voltage battery system 100 includes battery management system or controller 102. Controller 102, among other functions, controls the operation of contactors 110, 112 and 114 to apply or remove the voltage from battery 104 to an output bus 160, 162. Contactor 112 is a pre-charge contactor which places a current limiting resistance 108 in series with battery 104 in a pre-charge operation intended to minimize in-rush current when the vehicle's electrical load first has battery potential applied thereto.

Element 106 of system 100 comprises a service disconnect circuit breaker.

Charger 160 is coupled to high voltage battery system 100 via bus 164, 166.

Battery system bus 160, 162 is coupled to a switched capacitor voltage converter or booster circuit 120 which is controlled by a converter controller 190 at outputs 128g, 130g, 132g, 134g, 136g, 138g, 140g, 142g and 144g. These controller outputs communicate with similarly numbered control gates on switching transistors 128, 130, 132, 134, 136, 138, 140, 142 and 144. Transistors 128, 130, 132, 134, 136, 138, 140, 142 and 144 may comprise insulated gate bipolar transistors (IGBT).

An output filter 126 may be used at the output V_{E} of converter 120. The filter is placed across the output bus of converter 120—i.e, 168, 170.

Bus 168, 170 is coupled in turn to traction power inverter module 150. TPIM 150 functions in a known manner to convert the potential signal appearing across bus 168, 170 into a three-phase output AC voltage signal at phase outputs 172, 174 and 176 for driving the coils of an electric motor 152.

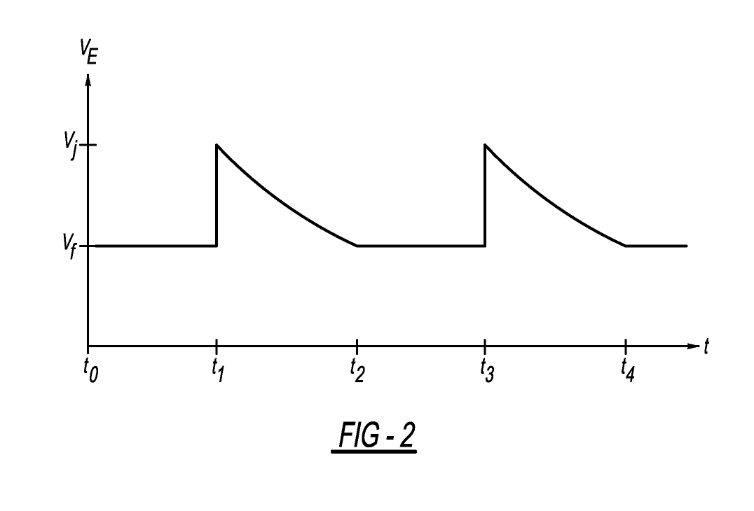

With reference to FIGS. 1 and 2, the voltage boosting system operates, as follows. At a beginning charging phase taking place during the interval between t₀ and t₁ of FIG. 2, capacitors 122 and 124 are placed in parallel to receive a charge voltage from battery 104. During this time period, the output V_{E} of battery booster 120 will be V_{f} whose value depends on the length of capacitive discharge interval to be discussed below.

Capacitors 122 and 124 are configured in parallel during this time interval by appropriate control of transistor switches 128, 130, 132, 134, 136, 138 and 140 via voltage booster management controller 190. More specifically, during the time from t₀ to t₁, controller 190 turns transistor switches 130, 132, 136 and 138 on or conductive while turning switches 128, 134 and 140 off, or nonconductive. Hence, it will be noted that TPIM 150 is disconnected from capacitors 122 and 124 during this charging phase, due to the nonconductive state of transistors 128 and 140. It will be understood that two capacitors are shown for the sake of example only. The DC-DC booster may be composed of many capacitors in a simple or complex parallel/series arrangement that switches to another or complex parallel/series arrangement in two or more steps.

In a voltage output drive period between t₁ and t₂ of FIG. 2, capacitors 122 and 124 are placed in series to effectively double the voltage placed across the booster output at V_{E}. The series connection of capacitors 122 and 124, the decoupling of booster or converter 120 from battery system 100 and the coupling of booster 120 to TPIM 150 are effected by controller 190 placing transistors 128, 134 and 140 in the on or conductive state and by placing transistors 130, 132, 136 and 138 in the off or open circuit state. Battery system 100 is effectively disconnected from converter 120 during t₁-t₂ by the nonconductive state of transistors 130 and 136.

It will be apparent that during this time period the initial potential across the battery booster 120 output at 168, 170 will be an increased voltage, e.g., twice, attained by each capacitor during the charging period, t₀-t₁. The final voltage at the end of the period t₁-t₂ will depend on the length of the time period and the characteristics of any smoothing filter, such as capacitor 126, that may be employed.

Transistors 142 and 144 remain off, or nonconductive, during the normal operation depicted in FIG. 2. These switches can be used in the conductive state to couple the battery system directly to the load, for example, during a pre-charge operation, by bypassing the capacitive elements of converter 120.

For each pulsing of the battery system output from an on to an off state, the above-described operations will repeat themselves in time intervals subsequent to t₂, as depicted in FIG. 2.

It will be understood by those skilled in the art that controllers 102 and 190 of FIG. 1, while shown as separate elements therein, could be combined into a single control element.

Finally, the converter output of FIG. 2 may be smoothed to a substantially DC voltage by filter 126 depicted as a simple capacitor but intended to be representative of a filter that may be of greater complexity than a single capacitor, such as one that includes at least one capacitor and at least one inductor or other elements. Alternatively, inverter 150 may be driven directly by the waveform of FIG. 2, when inverter 150 is capable of utilizing a non-DC input.

What is claimed is:

1. A voltage booster system comprising:
a battery coupled to a first bus;
a switched capacitor voltage converter having an input coupled to the first bus and an output coupled to an electric load via a second bus, the converter including at least first and second capacitors coupled to a plurality of switches; and
a controller unit operative to provide a pulsating voltage to the converter input, the pulsating voltage varying between a preselected voltage level during a first phase and a substantially zero voltage level during a second phase, the controller further operative to control the plurality of switches so as to couple the at least first and second capacitors in parallel during the first phase and so as to couple the at least first and second capacitors in series during the second phase.

2. The voltage booster system of claim 1, wherein the control unit is further operative to control the plurality of switches so as to decouple the at least first and second capacitors from the electric load during the first phase and to couple the at least first and second capacitors to the electric load during the second phase.

3. The voltage booster system of claim 2 further comprising a smoothing filter coupled across the converter outlet.

4. The voltage booster system of claim 1 wherein the battery comprises a high voltage battery system of an electric vehicle.

5. The voltage booster system of claim 4 wherein the electric load comprises a traction power inverter module operative to generate a three-phase voltage signal at an inverter output.

6. The voltage booster system of claim 5 further comprising an electric motor coupled for receipt of the three-phase voltage signal.

7. A method for boosting voltage available from a battery system during an electric load, the method comprising:
placing a switched capacitor voltage converter between the battery system and the load;
coupling the battery system to the converter and decoupling the converter from the load during a first phase;
decoupling the battery system from the converter and coupling the converter to the load during a second phase;
placing the at least first and second capacitors of the converter in parallel across a battery system output during the first phase; and
placing the at least first and second capacitors in series across an output of the converter during the second phase.

8. The method of claim 7 further comprising placing a smoothing filter across the converter output.
